(19) United States
(12) Patent Application Publication
(10) Pub. No.: US 2024/0193996 A1
(43) Pub. Date: Jun. 13, 2024

(54) DUAL AUTHENTICATION METHOD FOR CONTROLLING A PREMISES SECURITY SYSTEM

(71) Applicant: The ADT Security Corporation, Boca Raton, FL (US)

(72) Inventors: Steven ELSE, Deerfield Beach, FL (US); Jatin PATEL, Boca Raton, FL (US)

(21) Appl. No.: 18/062,912

(22) Filed: Dec. 7, 2022

(51) Int. Cl. G06V 40/70; G06V 40/12; G06V 40/16; G08B 25/00; G08B 25/12; G08B 29/18

(52) U.S. Cl. CPC G06V 40/70; G06V 40/1365; G06V 40/176; G08B 25/008; G08B 25/12; G08B 29/18

(57) ABSTRACT

A control device in a premises security system for authorizing a user, configured to receive a video of the user, the video being recorded during an authorization process, perform facial recognition on the video to identify the user, determine at least one facial expression of the user captured on the video, receive a fingerprint scan associated with a first finger of the user, authenticate the user based at least in part on the facial recognition, the at least one facial expression, and the fingerprint scan, and perform at least one premises security action based at least in part on the authentication.

### TECHNICAL FIELD

The present technology is generally related biometric authentication for configuring a premises security system, such as a dual biometric authentication technique for controlling the premises security system.

### BACKGROUND

Some existing premises security systems may require users to program and recall numerical user codes for accessing a user interface and/or for configuring (e.g., arming and disarming) the system. These systems, however, suffer from a risk of false alarms due to user input error in forgetting or mistyping these user codes, which may include passwords, configuration codes (e.g., “4” to disarm, “5” to arm, “6” to set off alarm, etc.), instructions, control information, etc.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of an example system comprising a premises security system according to principles of the present disclosure;

FIG. 2 is a block diagram of a control device according to some embodiments of the present disclosure;

FIG. 3 is a flowchart diagram of an of an example process implemented by a control device according to one or more embodiments of the present disclosure; and

FIG. 4 is an illustration of an example control device according to one or more embodiments of the present disclosure.

### DETAILED DESCRIPTION

Before describing in detail exemplary embodiments, it is noted that embodiments may reside in combinations of apparatus components and processing steps related to dual authentication for controlling a premises security system, such as for arming and/or disarming a premises security system. Accordingly, components have been represented where appropriate by conventional symbols in the drawings, focusing on only those specific details that may facilitate understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a,” “an” and “the” are intended to include the plural forms as well, unless the context clearly indicates otherwise. The terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

In some embodiments, the term “control device” may be used herein to indicate any electronic device for controlling one or more functionalities or states of a premises security system, for example, a control panel, alarm panel, smartphone application, etc. In some embodiments, a control device may be implemented on one or more other devices, such as a local premises device, a control panel, a user's smartphone device, a local server, a remote server, a cloud-based server, etc.

The terminology used herein is for the purpose of describing particular embodiments only and is not intended to be limiting of the concepts described herein. As used herein, the singular forms “a,” “an” and “the” are intended to include the plural forms as well, unless the context clearly indicates otherwise. The terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments of the present disclosure provide a dual authentication input for arming or disarming a premises security system. In some embodiments, this may advantageously eliminate or reduce the need to program and/or use user codes (e.g., alphanumerical codes) for arming and/or disarming a premises security system. Some embodiments of the present disclosure may also advantageously enhance security of the premises security system by reducing or eliminating the risk of false alarms caused by user input errors, e.g., forgotten or mistyped user codes.

Some embodiments of the present disclosure may use premises security system hardware (e.g., an on-board camera, processing circuitry, etc.) to perform a first biometric authentication (e.g., facial recognition). Some embodiments may use additional hardware (e.g., a fingerprint reader, processing circuitry, etc.) to perform a second biometric authentication (e.g., a fingerprint recognition). In some embodiments, the end user presents her face to the premises security system to perform a facial recognition, followed by the end user presenting her finger(s) to the fingerprint reader (e.g., an in-screen fingerprint reader), and the premises security system (e.g., processing circuitry therein) performs a dual authentication procedure, for example, for arming or disarming the premises security system, as described herein.

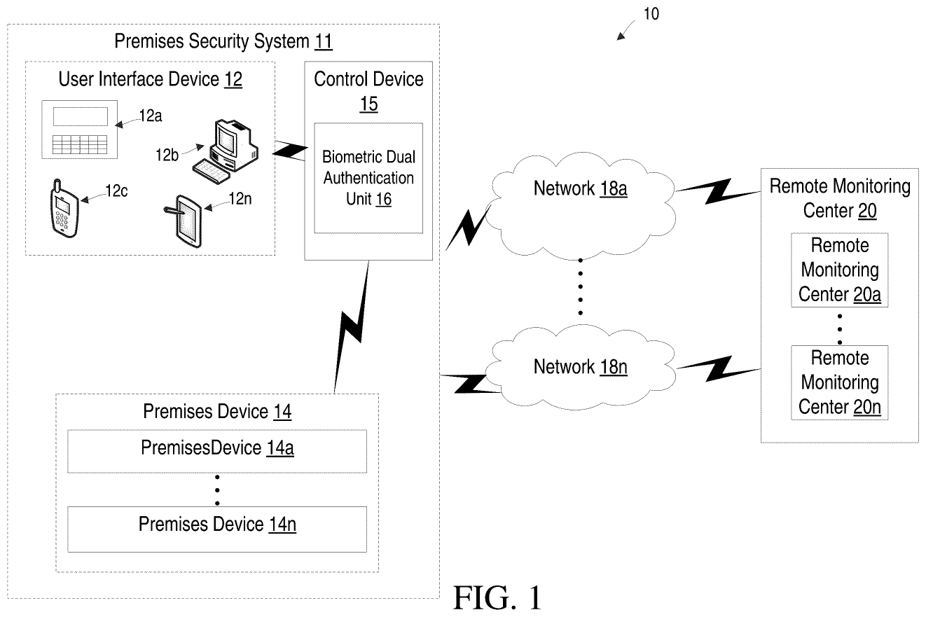

Referring now to the drawing figures in which like reference designators refer to like elements there is shown in FIG. 1 a system designated generally as “10.” System 10 may include premises security system 11 where premises security system 11 includes and/or is associated with one or more user interface devices 12a to 12n (collectively referred to as “user interface device 12”), one or more premises devices 14a-14n (collectively referred to as “premises device 14”) and control device 15. The user interface devices 12, premises device 14, and control device 15 may communicate via one or more wired or wireless communication channels.

Premises device 14a-14n may include sensors, control panels, control devices, images capture devices, life safety devices, lifestyle devices and/or other devices. For example, the types of sensors may include various life safety related sensors such as motion sensors, fire sensors, carbon monoxide sensors, flooding sensors and contact sensors, among other sensor types. The control devices may include, for example, one or more lifestyle related devices configured to adjust at least one premises setting, such as lighting, temperature, energy usage, door lock and power settings, among other settings associated with the premises or devices on the premises. Image capture devices may include digital cameras and/or video cameras, among other image capture devices.

Control device 15, which may be, for example, a touchscreen control panel, may include a biometric dual authentication unit 16 configured for authenticating a dual biometric user input, and for determining or configuring a state of the control device 15 and/or premises security system 11, and/or determining or configuring an indication or message for transmission to another entity, e.g., based on the biometric dual authentication performed at least partially at the control device 15 (e.g., by biometric dual authentication unit 16), as described herein.

System 10 may further include one or more networks 18a to 18n (collectively referred to as “network 18”), and one or more remote monitoring centers 20a to 20n (collectively referred to as “remote monitoring center 20”), communicating with each other or with at least one other entity in system 10.

User interface device 12 may be a wireless device that allows a user to communicate with control device 15. User interface device 12 may be a portable control keypad 12a, computer 12b, mobile phone 12c and tablet 12n, among other devices that allow a user to interface with control device 15 and/or one or more premises devices 14. User interface device 12 may communicate at least with control device 15 using one or more wired and/or wireless communication protocols. For example, portable control keypad 12a may communicate with control device 15 via a ZigBee based communication link, e.g., network based on Institute of Electrical and Electronics Engineers (IEEE) 802.15.4 protocols, and/or Z-wave based communication link, or over the premises' local area network, e.g., network-based on Institute of Electrical and Electronics Engineers (IEEE) 802.11 protocols, user interface device 12.

The premises devices 14 may communicate with control device 15 via proprietary wireless communication protocols and may also use Wi-Fi. Other communication technologies can also be used, and the use of Wi-Fi is merely an example.

Control device 15 may provide one or more of management functions, monitoring functions, analysis functions, control functions such as power management, premises device management and alarm management and/or analysis, among other functions to premises security system 11. In particular, control device 15 may manage one or more life safety or lifestyle features. Life safety features may correspond to security system functions and settings associated with premises conditions that may result in life threatening harm to a person, such as carbon monoxide detection and intrusion detection. Lifestyle features may correspond to security system functions and settings associated with video capturing devices and non-life-threatening conditions of the premises, such as lighting and thermostat functions.

Control device 15 may communicate with network 18 via one or more communication links. In particular, the communications links may be broadband communication links such as a wired cable modem or Ethernet communication link, and digital cellular communication link, e.g., long term evolution (LTE) and/or 5G based link, among other broadband communication links. Broadband as used herein may refer to a communication link other than a plain old telephone service (POTS) line. Ethernet communication link may be an IEEE 802.3 or 802.11 based communication link. Network 18 may be a wide area network, local area network, wireless local network and metropolitan area network, among other networks. Network 18 provides communications among one or more of control device 15, remote monitoring center 20 and premises device 14.

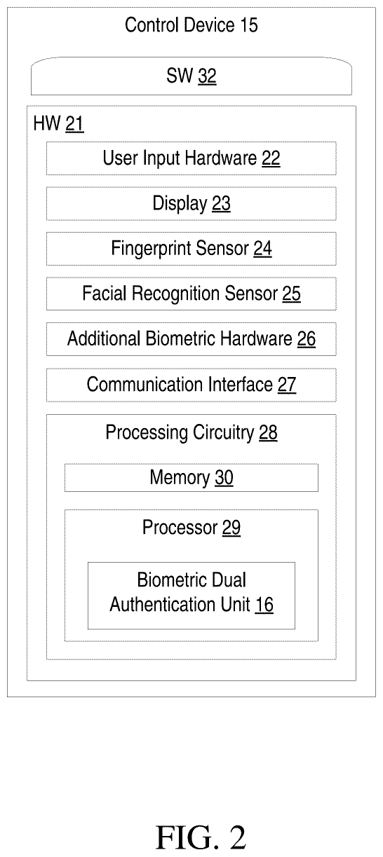

With respect to FIG. 2, the example system 10 includes a control device 15 that includes hardware 21 enabling the control device 15 to communicate with one or more entities in system 10 and to perform one or more functions described herein.

The hardware 21 may include user input hardware 22, which may include, for example, one or more of a physical button, a touch button, a touchless button, a touchscreen display touch interface, a switch, a knob, a dial, gesture detector, etc. In some embodiments, user input hardware 22 may include a voice input component, e.g., a component that uses voice recognition to receive spoken verbal commands from a user, such as “activate the sensor”, “activate an alarm”, “enter bypass mode”, “exit bypass mode,” etc.

The hardware 21 may include a display 23, such as an LED display, LCD display, OLED display, etc. In some embodiments, the display 23 may be a touchscreen display, which may include integrated and/or built-in input hardware 22 (e.g., a touch interface).

The hardware 21 may include a fingerprint sensor 24. Fingerprint sensor 24 may be a separate component and/or may be integrated and/or built-in to one or more other components of control device 15, such as display 23 (e.g., a fingerprint sensor 24 built-in to the display 23 and/or positioned underneath a portion of the display 23), user input hardware 22 (e.g., a physical button including a fingerprint sensor 24), etc.

The hardware 21 may include a facial recognition sensor 25, which may include one or more image sensors, rangefinder sensors, infrared sensors, etc. The facial recognition sensor 25 may be a separate component and/or may be integrated and/or built-in to one or more other components of control device 15, such as a camera placed underneath a portion of display 23.

The hardware 21 may include additional biometric hardware 26, such as one or more hand geometry sensors, retina and/or iris pattern sensors, voice recognition sensors, etc.

The hardware 21 may include a communication interface 27 for setting up and maintaining at least a wired and/or wireless connection to one or more entities in system 10 such as remote monitoring center 20, a premises device 14, user interface device 12, another control device 15, etc.

In the embodiment shown, the hardware 21 of the control device 15 further includes processing circuitry 28. The processing circuitry 28 may include a processor 29 and a memory 30. In particular, in addition to or instead of a processor, such as a central processing unit, and memory, the processing circuitry 28 may comprise integrated circuitry for processing and/or control, e.g., one or more processors, processor cores, field programmable gate arrays (FPGAs), and/or application specific integrated circuits (ASICs) adapted to execute instructions. The processor 29 may be configured to access (e.g., write to and/or read from) the memory 30, which may comprise any kind of volatile and/or nonvolatile memory, e.g., cache and/or buffer memory, random access memory (RAM), read-only memory (ROM), optical memory, and/or erasable programmable read-only memory (EPROM).

Thus, the control device 15 further has software 32 stored internally in, for example, memory 30, or stored in external memory (e.g., database, storage array, network storage device, etc.) accessible by the control device 15 via an external connection. The software 32 may be executable by the processing circuitry 28. The processing circuitry 28 may be configured to control any of the methods and/or processes described herein and/or to cause such methods, and/or processes to be performed, e.g., by control device 15. Processor 29 corresponds to one or more processors 29 for performing control device 15 functions described herein. The memory 30 is configured to store data, programmatic software code and/or other information described herein. In some embodiments, the software 32 may include instructions that, when executed by the processor 29 and/or processing circuitry 28, cause the processor 29 and/or processing circuitry 28 to perform the processes described herein with respect to control device 15. For example, processing circuitry 28 of the control device 15 may include biometric dual authentication unit 16, which is configured to perform one or functions described herein such as with respect to biometrically dual authenticating a user, e.g., based on captured biometric data received from fingerprint sensor 24, facial recognition sensor 25, and/or additional biometric hardware 26, for example, by comparing the captured biometric data with authentic and/or reference biometric data stored in a database (e.g., stored in memory 30, in control device 15, in a remote server, etc.), and modifying a state of the control device 15 and/or premises security system 11 (e.g., based on the result of the biometric dual authentication unit 16 comparing captured dual biometric data with authentic and/or reference biometric data), modifying the configuration of the control device 15 to cause it to respond differently to one or more stimuli, determining a control device 15 signal, causing transmission of the signal to another premises security entity (e.g., premises device 14, remote monitoring center 20, etc.), etc.

Although FIGS. 1 and 2 show biometric dual authentication unit 16 as being within a respective processor, this unit may be implemented such that a portion of the unit is stored in a corresponding memory within the processing circuitry. In other words, the unit may be implemented in hardware or in a combination of hardware and software within the processing circuitry.

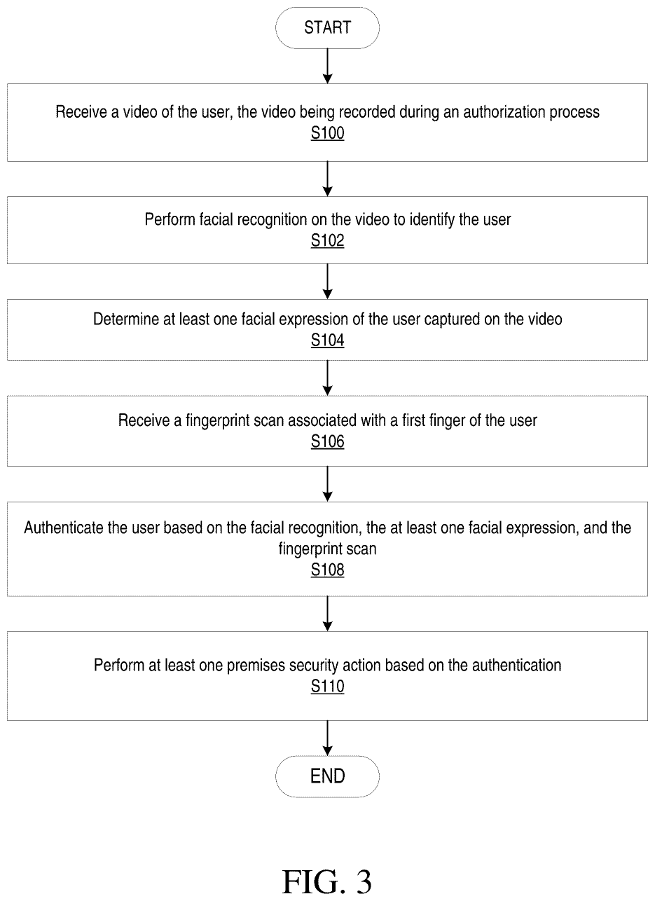

FIG. 3 is a flowchart of an example process implemented by a control device 15 according to one or more embodiments of the present disclosure. One or more blocks described herein may be performed by one or more elements of control device 15 such as by one or more of detection hardware 21, user input hardware 22, display 23, fingerprint sensor 24, facial recognition sensor 25, additional biometric hardware 26, communication interface 27, processing circuitry 28 (including the biometric dual authentication unit 16), processor 29, memory 30, etc. Control device 15 is configured to receive (Block S100) a video of the user, where the video is recorded during an authorization process, as described herein. Control device 15 is configured to perform (Block S102) facial recognition on the video to identify the user, as described herein. Control device 15 is configured to determine (Block S104) at least one facial expression of the user captured on the video, as described herein. Control device 15 is configured to receive (Block S106) a fingerprint scan associated with a first finger of the user, as described herein. Control device 15 is configured to authenticate (Block S108) the user based on the facial recognition, the at least one facial expression, and the fingerprint scan, as described herein. Control device 15 is configured to perform (Block S110) at least one premises security action based on the authentication, as described herein.

According to one or more embodiments, the at least one premises security action includes at least one of triggering a silent alarm of the premises security system 11, triggering an audible alarm of the premises security system, disarming at least a portion of the premises security system 11, arming at least a portion of the premises security system 11, or modifying at least one configuration of the premises security system 11.

According to one or more embodiments, control device 15 is further configured to authenticate the user based on the facial recognition, the at least one facial expression, and the fingerprint scan includes identifying a mapping between the at least one facial expression and the at least one premises security action.

According to one or more embodiments, the at least one facial expression maps to the triggering of the silent alarm such that, for example, a facial expression maps to a specific premises security action.

According to one or more embodiments, the facial expression includes a frightened facial expression, a winking facial expression, an eyes closed facial expression, or a smiling facial expression. Other facial expressions may be used without deviating from the scope of the present disclosure.

According to one or more embodiments, the determining of the at least one facial expression of the user captured on the video includes determining an ordered plurality of facial expressions of the user. For example, a user first presenting a happy facial expression, followed by a frightened facial expression, would represent a first ordered pattern, whereas a user presenting a sad facial expression followed by an expressionless facial expression would represent a second ordered pattern.

According to one or more embodiments, the control device 15 is further configured to authenticate the user based on the facial recognition, the at least one facial expression, and the fingerprint scan by mapping the fingerprint scan of the user to a corresponding reference fingerprint of a plurality of reference fingerprints, and mapping the corresponding reference fingerprint to at least one corresponding premises security action, and is further configured to perform the at least one premises security action based on the authentication by performing the at least one corresponding premises security action associated with both of the corresponding reference fingerprint and the at least one facial expression.

For example, the control device 15 may be configured so that a user may scan her index finger while displaying a sad facial expression, which may cause a first premises security action, whereas the user may scan here middle finger while displaying a happy facial expression, which may cause a second premises security action to occur. Thus, in addition to authenticating a facial recognition and a fingerprint recognition, the control device 15 may be configured to perform one or more premises security actions based on which finger(s) were (successfully) authenticated, and which facial expression(s) were displayed by the user during the facial recognition. The facial recognition and fingerprint recognition may occur simultaneously, within a predefined time difference of one another, and/or may occur in a sequence (e.g., fingerprinting first, followed by facial recognition, or vice-versa).

In some embodiments, other biometric inputs may be used, e.g., via additional biometric hardware 26, in accordance with these techniques. For example, a voice recognition technique similar to the fingerprinting technique described above may be used, but instead of mapping premises security actions to a first finger and a second finger, the user may use a left eye vs. a right eye for the eye recognition, where each eye is mapped to a different premises security action. As another example, a user may use voice recognition in conjunction with a fingerprint authentication, facial recognition, etc., where different voice tones, emotions, pitches, etc. (e.g., happy voice, sad voice, frightened voice, etc.) may be mapped to different premises security actions. Thus, embodiments of the present disclosure may enable dual (or triple, quadruple, etc.) authentication and control of a premises security system 11 using a variety of biometric inputs and modalities.

According to one or more embodiments, the triggering of the silent alarm is mapped to a first reference fingerprint of the user, and the disarming of at least a portion of the premises security system 11 is mapped to a second reference fingerprint of the user different from the first reference fingerprint of the user, where the first reference fingerprint and second reference fingerprint are preconfigured in the premises security system 11.

According to one or more embodiments, the control device 15 is further configured to perform at least one premises security action based on the authentication by arming the premises security system 11 based on the fingerprint scan mapping to a first reference fingerprint associated with arming the premises security system, and the at least one facial expression mapping to a first reference facial expression associated with arming the premises security system, and is further configured to disarm the premises security system 11 based on the fingerprint scan mapping to a second reference fingerprint associated with disarming the premises security system 11, and the at least one facial expression mapping to a second reference facial expression associated with disarming the premises security system 11.

According to one or more embodiments, the first reference facial expression corresponds to a first ordered facial expression pattern, and the second reference facial expression corresponds to a second ordered facial expression pattern different than the first ordered facial expression pattern.

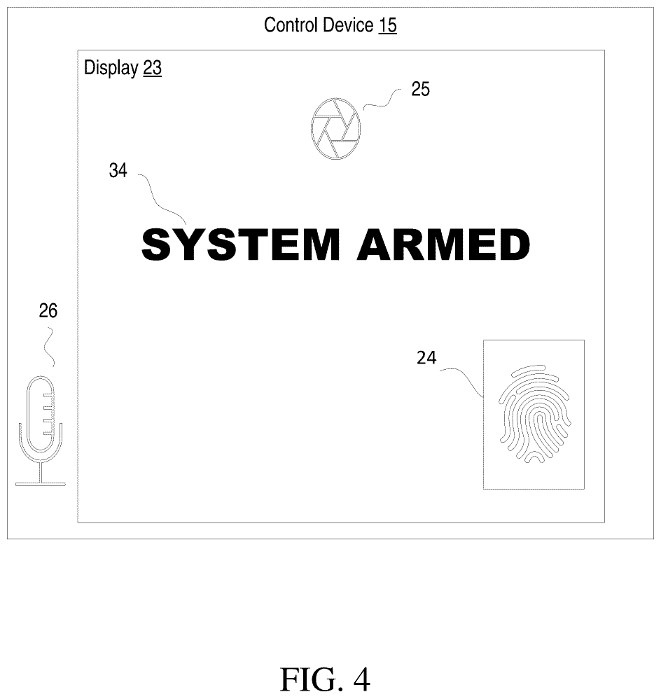

FIG. 4 is an illustration of an example control device 15, such as a control panel, in a premises security system 11. In this example, control device 15 includes a display 23, which includes a built-in fingerprint sensor 24, facial recognition sensor 25, and additional biometric hardware 26 (e.g., a voice sensor). A region of the display 23 displays text, e.g., indicating a state of the control device 15 and/or premises security system 11.

Thus, embodiments of the present disclosure may use dual authentication to configure and/or control (e.g., arm and/or disarm) a premises security system 11. For example, during a setup of the premises security system 11, the user may present her face to the on-board camera (facial recognition sensor 25) of the premises security system to learn the user's facial profile. Next, the user will present a finger or finger(s) to the fingerprint sensor 24 (which may be, e.g., an in-screen fingerprint reader) to learn in user's fingerprint profile.

In some embodiments, if the user wishes to arm or disarm the premises security system, the user may follow a two-step process, for example. First, the user may present her face to the on-board camera, which may perform facial recognition to identify the user. Then, the user may present the same finger(s) used when the user registered her fingerprint(s) during a registration process to the in-screen fingerprint reader.

Thus, embodiments of the present disclosure may use both of the above information to authenticate a user and to successfully arm and/or disarm and/or otherwise change the configuration or state of premises security system 11.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. Each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method implemented by a control device in a premises security system for authorizing a user, the method comprising:
receiving a video of the user, the video being recorded during an authorization process;
performing facial recognition on the video to identify the user;
determining at least one facial expression of the user captured on the video;
receiving a fingerprint scan associated with a first finger of the user;
authenticating the user based at least in part on the facial recognition, the at least one facial expression, and the fingerprint scan; and
performing at least one premises security action based at least in part on the authentication.

2. The method of claim 1, wherein the at least one premises security action comprises at least one of:
triggering a silent alarm of the premises security system;
triggering an audible alarm of the premises security system;
disarming at least a portion of the premises security system;
arming at least a portion of the premises security system; or
modifying at least one configuration of the premises security system.

3. The method of claim 2, wherein:
authenticating the user based at least in part on the facial recognition, the at least one facial expression, and the fingerprint scan comprises identifying a mapping between the at least one facial expression and the at least one premises security action.

4. The method of claim 3, wherein the least one facial expression maps to the triggering of the silent alarm.

5. The method of claim 4, wherein the facial expression comprises:
a frightened facial expression;
a winking facial expression;
an eyes closed facial expression; or
a smiling facial expression.

6. The method of claim 1, wherein determining the at least one facial expression of the user captured on the video comprises determining an ordered plurality of facial expressions of the user.

7. The method of claim 3, wherein:
authenticating the user based at least in part on the facial recognition, the at least one facial expression, and the fingerprint scan comprises:
mapping the fingerprint scan of the user to a corresponding reference fingerprint of a plurality of reference fingerprints; and
mapping the corresponding reference fingerprint to at least one corresponding premises security action; and
performing the at least one premises security action based at least in part on the authentication comprises performing the at least one corresponding premises security action associated with both of the corresponding reference fingerprint and the at least one facial expression.

8. The method of claim 7, wherein:
the triggering of the silent alarm is mapped to a first reference fingerprint of the user; and
the disarming of at least a portion of the premises security system is mapped to a second reference fingerprint of the user different from the first reference fingerprint of the user, the first reference fingerprint and second reference fingerprint being preconfigured in the premises security system.

9. The method of claim 1, wherein performing at least one premises security action based at least in part on the authentication comprises:
arming the premises security system based at least in part on:
the fingerprint scan mapping to a first reference fingerprint associated with arming the premises security system; and
the at least one facial expression mapping to a first reference facial expression associated with arming the premises security system; and
disarming the premises security system based at least in part on:
the fingerprint scan mapping to a second reference fingerprint associated with disarming the premises security system; and
the at least one facial expression mapping to a second reference facial expression associated with disarming the premises security system.

10. The method of claim 9, wherein the first reference facial expression corresponds to a first ordered facial expression pattern; and
the second reference facial expression corresponds to a second ordered facial expression pattern different than the first ordered facial expression pattern.

11. A control device in a premises security system for authorizing a user, the control device comprising processing circuitry configured to:
receive a video of the user, the video being recorded during an authorization process;
perform facial recognition on the video to identify the user;
determine at least one facial expression of the user captured on the video;
receive a fingerprint scan associated with a first finger of the user;
authenticate the user based at least in part on the facial recognition, the at least one facial expression, and the fingerprint scan; and
perform at least one premises security action based at least in part on the authentication.

12. The control device of claim 11, wherein the at least one premises security action comprises at least one of:
triggering a silent alarm of the premises security system;
triggering an audible alarm of the premises security system;
disarming at least a portion of the premises security system;
arming at least a portion of the premises security system; or
modifying at least one configuration of the premises security system.

13. The control device of claim 12, wherein the processing circuitry is further configured to:
authenticate the user based at least in part on the facial recognition, the at least one facial expression, and the fingerprint scan comprises identifying a mapping between the at least one facial expression and the at least one premises security action.

14. The control device of claim 13, wherein the at least one facial expression maps to the triggering of the silent alarm.

15. The control device of claim 14, wherein the facial comprises:
a frightened facial expression;
a winking facial expression;
an eyes closed facial expression; or
a smiling facial expression.

16. The control device of claim 11, wherein determining the at least one facial expression of the user captured on the video comprises determining an ordered plurality of facial expressions of the user.

17. The control device of claim 13, wherein the processing circuitry is further configured to:
authenticate the user based at least in part on the facial recognition, the at least one facial expression, and the fingerprint scan by:
mapping the fingerprint scan of the user to a corresponding reference fingerprint of a plurality of reference fingerprints; and
mapping the corresponding reference fingerprint to at least one corresponding premises security action; and
perform the at least one premises security action based at least in part on the authentication by performing the at least one corresponding premises security action associated with both of the corresponding reference fingerprint and the at least one facial expression.

18. The control device of claim 17, wherein:
the triggering of the silent alarm is mapped to a first reference fingerprint of the user; and
the disarming of at least a portion of the premises security system is mapped to a second reference fingerprint of the user different from the first reference fingerprint of the user, the first reference fingerprint and second reference fingerprint being preconfigured in the premises security system.

19. The control device of claim 11, wherein the processing circuitry is further configured to perform at least one premises security action based at least in part on the authentication by:
arming the premises security system based at least in part on:
the fingerprint scan mapping to a first reference fingerprint associated with arming the premises security system; and
the at least one facial expression mapping to a first reference facial expression associated with arming the premises security system; and
disarming the premises security system based at least in part on:
the fingerprint scan mapping to a second reference fingerprint associated with disarming the premises security system; and
the at least one facial expression mapping to a second reference facial expression associated with disarming the premises security system.

20. The control device of claim 19, wherein the first reference facial expression corresponds to a first ordered facial expression pattern; and
the second reference facial expression corresponds to a second ordered facial expression pattern different than the first ordered facial expression pattern.
